(19) United States
(12) Patent Application Publication
(10) Pub. No.: US 2010/0093439 A1
(43) Pub. Date: Apr. 15, 2010

(54) INTERACTIVE NETWORK GAME AND METHODS THEREOF

(75) Inventor: Aaron Brady, San Jose, CA (US)

Correspondence Address: LARSON NEWMAN & ABEL, LLP, 5914 WEST COURTYARD DRIVE, SUITE 200, AUSTIN, TX, 78730, US

(73) Assignee: NC INTERACTIVE, INC., Austin, TX (US)

(21) Appl. No.: 12/252,281

(22) Filed: Oct. 15, 2008

(51) Int. Cl. A63F 9/24; G06F 19/00

(52) U.S. Cl. 463/42; 463/43

(57) ABSTRACT

A method of providing a game session for a network game includes communicating information for the game session to a game participant. The game participant interacts with the game, thereby accumulating a game session attribute, such as currency, experience points, and the like. A portion of the accumulated game session attribute is allocated to a game character associated with a non-participant of the game session. In an embodiment, this allows a character associated with a player that is unable to attend the game session to achieve the benefits of the game session, so that the character is able to maintain parity with other characters in a gaming group.

### FIELD OF THE DISCLOSURE

The present disclosure relates to networked games and more particularly to game modes for networked games.

### BACKGROUND

Interactive online environments, such as multiplayer online games, have become increasingly popular in recent years. In such environments, a game character, typically represents a participant in the online environment. The participant interacts with the online environment by manipulating the game character. For example, by moving the avatar through the online environment, the participant can explore the environment. Interactions with the online game can take the form of the in-game character fighting, communicating, or otherwise interacting with computer controlled characters and events. Other interactions can take the form of battles or other interactions between characters. The user experience with a network game can be improved by enhancing the immersivity and flexibility of the game environment

### BRIEF DESCRIPTION OF THE DRAWINGS

The present disclosure may be better understood, and its numerous features and advantages made apparent to those skilled in the art by referencing the accompanying drawings.

FIG. 1 illustrates a block diagram of a communication system 100 in accordance with one embodiment of the present disclosure.

FIG. 2 illustrates a diagram of a particular embodiment of a character attribute information of FIG. 1.

FIG. 3 illustrates a flow diagram of a method of providing a network game experience in accordance with one embodiment of the present disclosure.

The use of the same reference symbols in different drawings indicates similar or identical items.

### DETAILED DESCRIPTION

A method of providing a game session for a network game includes communicating information for the game session to a game participant. The game participant interacts with the game, thereby accumulating a game session attribute, such as currency, experience points, and the like. A portion of the accumulated game session attribute is allocated to a game character associated with a non-participant of the game session. In an embodiment, this allows a character associated with a player that is unable to attend the game session to achieve the benefits of the game session, so that the character is able to maintain parity with other characters in a gaming group.

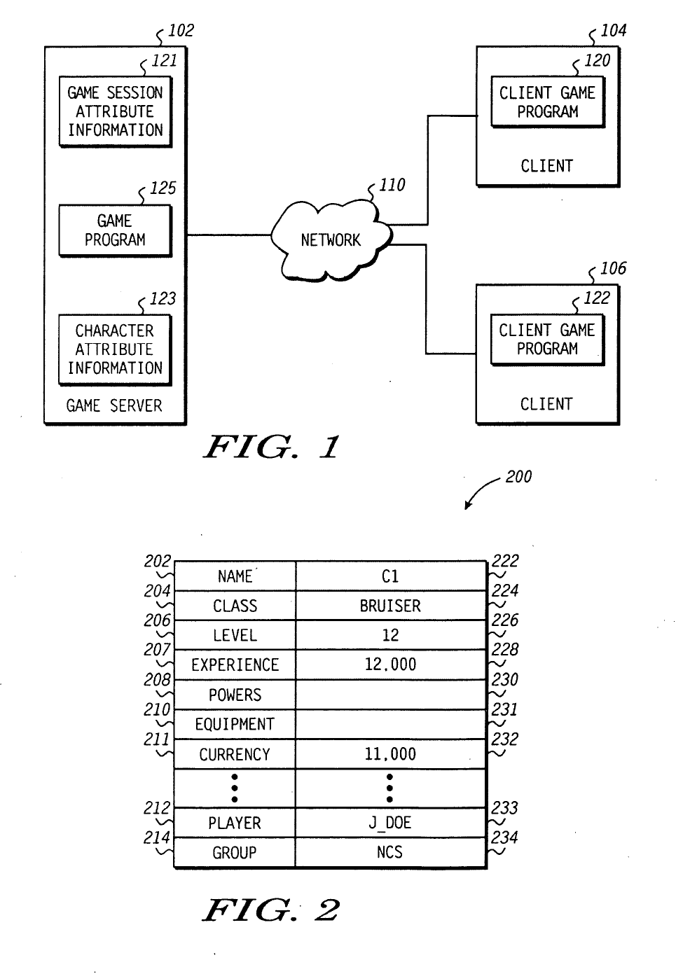

FIG. 1 illustrates a block diagram of a communication system 100 in accordance with one embodiment of the present disclosure. The communication system 100 includes a wide area network 110 connected to a game server 102 and client devices 104 and 106. The wide area network 110 can be a packet switched network that provides a physical communication layer to route packets between the game server 102 and the client device 104 and 106. In an embodiment, the wide area network 110 is the Internet.

The game server 102 is a computer device, such as a computer configured as a server device, which executes a game program 125. The game program 125 interacts with a game program 120 and a game program 122 at the client devices 104 and 106, respectively, to create an online gaming environment. To illustrate, the game program 125 can communicate information representing game objects. The game objects can represent any object in the online game, including game avatars, non-player characters, environmental objects, and the like. In addition, the game program can access character attribute information 123 to instantiate player characters in the game environment. As used herein, a player character refers to an in-game character associated with a player of the online game. A player refers to a person that is associated with a designated player character. A participant refers to a player that is participating in a particular game session, as described further herein.

The game program 125 is configured to communicate information indicative of game objects and in-game avatars associated with player characters via the network 110. The game program 125 is further configured to receive information via the network 110 indicative of player input information. The player input information indicates a player's interaction with the online environment. For example, the player input information can include requests to manipulate game objects, interact with non-player or other player characters, and the like. Thus, as new participants are added to a game session, the game program 125 instantiates new objects representing avatars for the new participants. As participants leave the game, the game program 125 can eliminate game objects representing avatars for the leaving participants. In addition, the game program 125 can change attributes of game objects based on participants' interactions with objects in the game. For example, the game program 125 can change positional attributes of game objects based on a participant manipulating the objects with his avatar, or based on the position of the objects changing relative to the avatar.

In conjunction with communicating the game environment, the game program 125 can access character attribute information 123. The character attribute information 123 stores information indicative of character attributes for game characters. An example of a data record 200 indicating character attribute information is illustrated at FIG. 2.

As illustrated, the data record 200 includes a number of fields, such as a name field 202, a class field 204, a level field 206, an experience field 207, a powers field 208, an equipment field 210, an in-game currency field 211, a player field 212, and a group field 214. Each field is associated with a field value indicating the character attribute associated with that field. Thus, field value 222 indicates a name associated with character represented by the data record 200. Field value 224 indicates a selected character class associated with the character. Field value 226 indicates a character level associated with the character. Field value 228 indicates an amount of experience points associated with the character. Field value 230 indicates one or more powers associated with the character, while field value 231 indicates one or more items of in-game equipment associated with the character. Field value 232 indicates an amount of in-game currency associated with the character.

Field value 233 indicates a player name or other identifier associated with the character. This allows the game program 125 to identify the player associated with the game character. The field value 234 indicates a group associated with the character. In an embodiment, multiple characters associated with the same or different players can be associated with a common player group, thereby allowing players to form in-game teams or clans.

Referring again to FIG. 1, based on the game objects and character attribute information 123, the game program 125 is configured to communicate data about the gaming environment via the wide area network 110 to the client devices 104 and 106. This allows participants at the client devices 104 and 106 to participate in a common game environment, so that one participant's interactions with the environment can affect the gaming experience of the other participant.

The game programs 120 and 122 are configured to provide a display of the gaming environment and an interface for a participant to interact with the environment. For ease of discussion, the configuration of the game program 120 will be described, but it will be appreciated that the game program 122 can be configured similarly.

The game program 120 sends communications via the wide area network 110 to the game server 102 indicating the position of an avatar associated with a participant of the game. To illustrate, the game program 120 provides an interface for a participant to enter (i.e. login to) the game. The participant enters authentication information, such as a password, and selects a particular character to represent the participant in the game environment. The game program 120 searches the character attribute information and locates the attribute information for the selected character and creates an in-game avatar representing the game character. The game program 120 further determines the position of the avatar in the game environment. When the participant first logs in, this position can be a predetermined initial position, a previously saved position, and the like. The game program 120 communicates the determined position to the game program 125 at the game server 102.

In response to receiving the positional data, the game program 125 determines which game objects are viewable or otherwise available for interaction by the participant's avatar. These game objects can include the avatars representing characters of the other game participants. The game program 125 provides attribute information about the game objects to the game program 120 via the wide area network 110. The game program 125 can provide additional information, such as information about the participant's character (e.g. inventory information, health information, class information, and the like) based on the character attribute information 123. Based on the received object information, the game program 120 provides a visual display representative of the game environment. In an embodiment, the game environment is displayed in a three-dimensional representation. As used herein, a three-dimensional representation refers to a representation that can be displayed on a two-dimensional display, but appears to be a three-dimensional object or environment. The game program 120 ensures that as an avatar moves through the game environment, the display of the environment is updated such that the environment appears three-dimensional. Accordingly, the game program 120 displays each game object so that the object appears three-dimensional in the game environment.

In response to a player providing input information requesting that the associated character interact with the game environment in a particular way, the game program 125 can access the data record associated with the character at the character attribute information 123 to determine the response to the request. For example, a player may request that the associated character attack an opponent. In response, the game program 125 can access the associated data record at the character attribute information to determine the characters level, strength, ability, and similar information. Based on this information, the game program 125 can determine a likelihood that the in-game character will be successful in the requested attack. Based on the likelihood, the game program 125 determines an attack result, and communicates information indicating the attack result to the player via the network 110. In an embodiment, the attack result is indicated visually, by a change to the appearance of the attacked opponent. Thus, as indicated by the above example, the character attribute information 123 allows individual characters to have varying attributes that affect the way an associated character interacts with the game environment, thereby providing for an improved player experience.

A designated portion of time during which a player interacts with the game environment is referred to here as a game session. The player initiates as game session by logging into the game and interacting with the game environment, and terminates the game session by logging out of the game or otherwise terminating her interactions with the game environment. For example, in an embodiment the player can terminate interactions with the game environment by exiting the game environment, but remain logged in to the game in order to perform other tasks, such as configuration of character information and the like.

In an embodiment, more than one player can participate in a game session. For example, players at both client 104 and client 106 can each initiate a game session by logging into the game and interacting with the game environment so that the characters associated with each player work towards a common goal, battle each other, or otherwise participate in a common game experience. Accordingly, the players thereby participate in a common game session.

In the illustrated embodiment of FIG. 1, the game server 102 stores game session attribute information 121. As referred to herein, a game session attribute refers to an attribute of the network game that can be accumulated during a designated game session by one or more game characters in the session. Thus, for example, during a game session a character can accumulate experience points by defeating opponents, completing in-game quests or other goals, and the like. Further, the character can accumulate an in-game currency, such as gold, credits, treasure, and the like during a game session. The accumulated experience points, in-game currency, and other game session attributes can be represented by number values or other information and stored as the game session attribute information 121. Accordingly, as a player interacts with the game environment, the game program 125 determines the game attribute accumulated based on the interaction and records the game attribute information 121. For example, in response to an in-game character defeating an opponent, the game program 125 determines an amount of experience gained by the character and stores the experience points as game session attribute information 121.

In addition, based on the game session attribute information 121, the game program 125 can update character attribute information 123. For example, based on experience points accumulated during a game session, the game program 125 can change an experience point attribute for a character at the character attribute information 123. Further, changes to a particular character attribute can cause changes in other attributes. For example, in response to accumulating a particular number of experience points, that game program 125 can change a level attribute associated with the character. This can further cause a change in a powers or ability attribute. Accordingly, as a player accumulates game session attributes, other attributes of the associated in-game character can change, providing for an evolving game experience. Further, the character attribute information 123 can be stored in a non-volatile memory so that changes to data records associated with particular characters are maintained between game sessions, allowing a character to evolve over multiple game sessions.

In addition, the game program 125 can use the game session attribute information 121 accumulated during a particular game session to alter character attribute information both for characters associated with game session participants and for characters associated with non-participants to the game session. Thus, for example, experience points accumulated during a game session can cause a change to an experience attribute for a character associated with a participant in the game session (e.g. the character that performed the in-game tasks that led to accumulation of the experience points). Further, the experience points can cause a change to an experience attribute for a character associated with a non-participant of the game session. This allows a character associated with a player to evolve even when the player is not able to attend particular game sessions, thereby ensuring that the character maintains similar abilities as the characters of the participants in the game session.

This can be better understood with reference to an example. Player1 and Player2 are players of the game associated with game program 125, and generally participate in game sessions together. Player1 wishes to participate in a game session, but Player2 is unable to participate at that time. Player1 initiates the game session and interacts with the game via his associated character, designated “Character1.” During the game session, Character1 accumulates experience points, which are recorded as game session attribute information 121. This causes changes in the character attribute information 123 associated with Character1. Such changes can cause Character1 to gain additional abilities, allowing the character to take on tougher in-game opponents, participate in more difficult in-game quests, and the like. However, if the character associated with Player2 (designated “Character2”) does not receive additional abilities as Character1 did, it will be difficult for Character2 to participate meaningfully in future game sessions with Character1, thereby reducing the likelihood that Player1 and Player2 will participate in future game sessions together and undesirably harming the game experience for each player. Thus, game program 125 applies changes to the character attribute information 121 associated with Character2, based on the game session attribute information 121. Character2 thereby maintains relative parity with Character1, enhancing the ability of Player1 and Player2 to participate in subsequent game sessions together.

In an embodiment, the game program 125 apportions the game session attribute information among characters associated with a common player group. In particular, the game program 125 can determine a group associated with the game session participants based on the field value 234 of the group field 214 associated with the characters of the participants. The game program can search the character attribute information 123 for additional non-participant character members of the identified group and change the associated attribute information for the indicated characters.

In a particular embodiment, the game program 125 apportions the game session attribute information 121 between game session participants in an equal fashion, so that the attribute information for each character is changed equally. For example, accumulated experience points can be allocated equally between participants' characters and non-participants' characters. In another embodiment, the game program 125 can allocate a greater share of the game session attribute to game session participants' characters than to non-participants' characters, thereby providing a “reward” for the participants. In still another embodiment, the amount of game session attribute allocated to a non-participant can be set so that it does not exceed a threshold value.

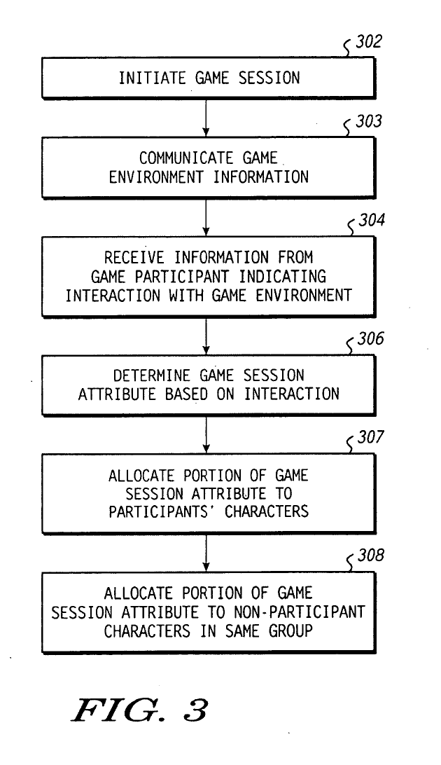

Referring to FIG. 3, a flow diagram of a particular embodiment of a method of providing a network game is illustrated. At block 302, the game program 125 receives a request to initiate a game session from a player. In an embodiment, the request is received from a client game program, such as the client game program 120, and communicated via the network 110. The request can be login information associated with the player or other request information. Further, the request can include multiple requests from different players requesting to participate in a common game session. For example, multiple players associated with a common game group can request to initiate a group game session.

At block 303, in response to the request the game program 125 communicates information to the client game program associated with the requesting player. The information allows the game environment to be displayed at the client device executing the game program. The game environment information can include information indicative of game objects, including in-game non-player characters, in-game equipment, in-game buildings, locations, and the like. The game environment information can also include information to provide for display and interaction with other in-game characters associated with other game session participants.

At block 304, the game program receives information via the network 110 indicating that a game session participant has interacted with the game environment. Such interactions can include moving through the game environment, interacting with a character associated with another player or with a non-player character, manipulating in-game objects, and the like. The information is communicated to the game program 125 in response to the game session participant interacting with a client device, thereby interacting with the associated client game program. For example, the participant can provide input information requesting that the character associated with the player attack a non-player character, cast a spell, search a room, pick-up an in-game object, and the like.

In response to the information indicating the game interaction, the game program 125 determines whether an adjustment to one or more game session attributes is indicated and, if so, the amount of adjustment indicated. For example, if the interaction indicates a character has eliminated another character, the game program 125 can determine that an amount of experience points associated with the game session should be adjusted, and determine the amount of adjustment. Similarly, if the interaction indicates a character has picked-up an amount of in-game currency, the game program 125 can determine the amount of adjustment to the currency associated with the character should be adjusted.

At block 307, the game program 125 allocates a portion of the game session attribute to one or more characters associated with one or more participants in the game session. In an embodiment, a portion of the game session attribute is allocated to a character of each game participant associated with a common character group or player group. The game program 125 allocates the game session attribute by adjusting the character attribute information associated with each character.

At block 308, the game program 125 allocates a portion of the game session attribute to one or more characters associated with one or more non-participants in the game session. In an embodiment, a portion of the game session attribute is allocated to a character of each non-participant associated with a common character group or player group. The game program 125 allocates the game session attribute by adjusting the character attribute information associated with each character. This allows non-participants to receive the rewards of a particular game session in which they do not participate, so that characters associated with a common character group or player group can evolve at a similar pace.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method, comprising:
receiving a request for a game session via a network;
communicating first information representative of a game environment via the network in response to the request;
receiving second information indicative of a first session participant's interaction with the game environment, the first session participant associated with a first game character;
determining a first game session attribute based on the second information; and
setting a first attribute of a second game character based on the first game session attribute, the second game character associated with a first non participant of the game session.

2. The method of claim 1, wherein the first game session attribute is indicative of an amount of experience points accumulated during the first game session.

3. The method of claim 2, wherein the first attribute of the second game character is a character experience attribute.

4. The method of claim 1, wherein the first game session attribute is indicative of an amount of in-game currency accumulated during the first game session.

5. The method of claim 1, wherein setting the first attribute of the second game character comprises:
assigning a first portion of the first game session attribute to the first game character;
assigning a second portion of the first game session attribute to the second game character; and
setting the first attribute based on the second portion.

6. The method of claim 5, wherein the first portion is larger than the second portion.

7. The method of claim 5, wherein assigning the second portion comprises:
determining an initial value based on a proportion of the game session attribute; and
setting the second portion to a threshold value in response to determining the initial value exceeds the threshold value.

8. The method of claim 1, further comprising:
determining a second game session attribute based on the second information; and
setting a second attribute of a second game character based on the second game session attribute.

9. The method of claim 1, further comprising:
setting a second attribute of a third game character based on the first game session attribute, the third game character associated with a second non participant of the game session.

10. The method of claim 1, wherein setting the first attribute of the second game character comprises setting the first attribute of the second game character in response to determining the first game character and the second game character are associated with a common game group.

11. The method of claim 1, wherein setting the first attribute of the second game character comprises setting the first attribute of the second game character in response to determining the first attribute does not exceed a threshold.

12. A computer readable medium physically embodying a computer program comprising a plurality of instructions to manipulate a processor, the plurality of instructions comprising instructions to:
receive a request for a game session via a network;
communicate first information representative of a game environment via the network in response to the request;
receive second information indicative of a first session participant's interaction with the game environment, the first session participant associated with a first game character;
determine a first game session attribute based on the second information; and
set a first attribute of a second game character based on the first game session attribute, the second game character associated with a first non participant of the game session.

13. The computer readable medium of claim 12, wherein the first game session attribute is indicative of an amount of experience points accumulated during the first game session.

14. The computer readable medium of claim 13, wherein the first attribute of the second game character is a character experience attribute.

15. The computer readable medium of claim 14, wherein the first game session attribute is indicative of an amount of in-game currency accumulated during the first game session.

16. The computer readable medium of claim 12, wherein the instructions to set the first attribute of the second game character comprise instructions to:
assign a first portion of the first game session attribute to the first game character;
assign a second portion of the first game session attribute to the second game character; and
set the first attribute based on the second portion.

17. The computer readable medium of claim 16, wherein the first portion is larger than the second portion.

18. The computer readable medium of claim 16, wherein the instructions to assign the second portion comprise instructions to:
determine an initial value based on a proportion of the game session attribute; and
set the second portion to a threshold value in response to determining the initial value exceeds the threshold value.

19. The computer readable medium of claim 12, wherein the plurality of instructions further comprise instructions to:
determine a second game session attribute based on the second information; and
set a second attribute of a second game character based on the second game session attribute.

20. The computer readable medium of claim 12, wherein the plurality of instructions further comprise instructions to:
set a second attribute of a third game character based on the first game session attribute, the third game character associated with a second non participant of the game session.
